(19) United States
(12) Patent Application Publication
(10) Pub. No.: US 2004/0020922 A1
(43) Pub. Date: Feb. 5, 2004

(54) Microwave multiboiling appliance and method for making coffee or similar drinks using microwave multiboiling appliances

(76) Inventor: Helio Vieira Alves, Sao Paulo (BR)

Correspondence Address: TRASK BRITT, P.O. BOX 2550, SALT LAKE CITY, UT, 84110, US

(21) Appl. No.: 10/629,080

(22) Filed: Jul. 29, 2003

Related U.S. Application Data
(63) Continuation-in-part of application No. PCT/BR02/00017, filed on Jan. 31, 2002.

(30) Foreign Application Priority Data
Feb. 1, 2001 (BR) PI 0104121

(51) Int. Cl. H05B 6/64

(52) U.S. Cl. 219/679; 219/687

(57) ABSTRACT

The invention reveals a microwave multiboiling appliance, which does not use a paper or fabric strainer. It makes coffee in a microwave oven with water and coffee powder, which is filtered when boiling, under pressure, through a metallic sieve, the coffee falling from the boiling receptacle directly into another receptacle of the appliance, ready to serve on the table in an excellent condition and with an unequaled taste, since it was boiled through friction of water and coffee in a microwave process, which refines the taste. It being filtered or strained in an average total time of about 2 minutes. Likewise, tea, loose herbs, leaves or sachets may also be utilized. Both pure milk and chocolate may also be boiled.

### CROSS-REFERENCE TO RELATED APPLICATIONS

This application is a continuation-in-part of International Application No. PCT/BR02/00017, filed Jan. 31, 2002, which is a continuation of Brazilian Application No. PI 0104121, filed Feb. 1, 2001, which are hereby incorporated by reference.

### BACKGROUND OF THE INVENTION

The present invention relates to a microwave (oven)-driven multiboiler appliance, useful to make express coffee with common coffee powder or soluble powder, as well as tea with herbs or loose leaves or in sachets, to make chocolate or to boil milk, or further to boil water under pressure, during pre-determinate period, without needing paper or fabric filter, the same appliance being further useful to serve other receptacle for strained items or to serve the boiled liquid directly on the table, being very efficient.

The invention is a new, and no domestic or foreign similar product is known to be used in a microwave oven, as conceived.

As it is known, coffee powder usually is mixed to water and brought to boil under fire action to be boiled or passed though a fabric or paper filter (named non-woven fabric) and, by reaching the boiling point, the liquid enters in ebullition and grows in volume, thereby forming gaseous bubbles which rise inside the receptacle, which then is removed from fire to prevent spillage, and then the liquid is filtered or strained in a, fabric or paper filter, thereby resulting in drinkable coffee.

Another way to make coffee is boiling water separately and then pouring it in the paper filter where coffee powder has been previously placed. Thus, the hot water passes through the coffee powder extracting its properties while it is strained by the filter in order to separate the powder. The coffee falls ready to be served into a suitable storage receptacle. The existence of a similar one that makes coffee in the same manner in microwave oven is known.

Further, another way of making coffee is that used in electric express coffee-makers, as well as small express coffee-makers that functions under the action of fire, both types stemming from Italy. Both the power-driven and the fire-driven coffee-makers produce coffee by the same method, that is to say, by using a water-storing container, where the water is intensely heated and changed into steam, which is moved by its own pressure and then passes through a small storing container where the coffee powder is stored, which has an axial metallic filter as a cover or steam intake and another metallic filter as an outlet of bottom. In this way, when the water in the form of steam goes through the first filter and into the coffee-powder storing container, it becomes liquid and extracts the properties of the coffee powder, which is rapidly done at this moment and only at this moment, and goes on under high continued pressure. The liquid, in the form of drinkable coffee, is then expelled into another container that receives such a drinkable liquid.

These coffee-makers known from the prior art have disadvantages, if applied to microwaves, since the coffee powder itself would be under the action of the microwaves. Instead, in these types of coffee-makers the coffee powder is stored in a metallic container that protects it from the microwaves. In this way, only the water would be caused to boil, the steam in contact with the powder placed in the container would become liquid and entrain the properties of the liquid coffee.

It is known that cooking foods by the action of microwaves will only occur in a liquid means, and that this cooking takes place upon vibration of the molecules of the food and of the liquid that contains the latter. With regard to the coffee-makers of the prior art mentioned above, since the coffee-powder storing container is made from a metallic material, the properties of the coffee will not be extracted by the action of the microwaves on the powder, by only when the steam from the boiling water quickly passes through the container holding the coffee powder.

In this case, the functioning of these coffee-makers at microwave ovens would be equal to their functioning on conventional stoves and, therefore, the properties and quality of the obtained coffee would be the same, without adding any advantages or improvement to the taste and to the process of obtaining it.

Differently, in the present invention, the coffee powder is mixed to the water and this mixture undergoes the action of the microwaves before and during its passage through the filter, extracting the properties of the coffee and of other foods, as long as they are already mixed in a liquid means (water or liquid milk) since the beginning. The same principle may apply to tea with herbs, chocolate and similar foods, in each case resulting in greater economy of the amount of food required for extraction of its properties into the liquid medium, by reason of the better refining thereof and of the taste, which is made more intensely by the direct action of the microwaves on the described liquid means.

The present invention also presents a technical evolution with its multiple use, by causing water or natural milk or else water mixed with powdered milk, coffee, chocolate, cocoa, teas, etc. to boil, which is carried out safely and without any external spilling, even if one employs a higher microwave power a longer exposure time than necessary for boiling.

So, as one can see, the present invention eliminates the problems of safety that possibly result from boiling liquids inside a microwave oven (spilling of liquid, superheated liquid, explosion, etc.). This is done (if the filter is clogged) by letting steam out of the a safety valve especially designed for this purpose, and further, if the pressure is extremely violent, by providing detachment of the container with cover that contains the filter, in order to avoid an explosion, and finally by providing walls of special construction in the form of a plastic sandwich with a metallic core in the final container that receives the final ready beverage and others. These walls are intended to prevent the action of the microwaves on this final container, which will prevent the ready-to-drink liquid from boiling.

According to the present is not necessary to use a paper or fabric strainer. The present invention allows to make coffee in microwave oven by bringing to boiled water mixed with express coffee powder, which is filtered while in ebullition, under pressure, through a metallic filtering sieve, the ready coffee being released directly in a receptacle which is also proper to serve on the table, thereby resulting in a coffee with an excellent and unequalled taste, since it is boiled through the friction of water and coffee molecules (a microwave oven process), which refines its maximum taste, being filtered or strained in a total average time of two minutes, which can vary according to water volume, quantity of coffee powder used and intensity of microwave “temperature” in the oven used.

Likewise, it also makes tea, with loose herbs, leaves or sachets, refining most herb properties used, since it is boiled by friction of its molecules under action of oven microwaves and further under vapor pressure.

Both pure milk and chocolate can be boiled likewise. Soluble products are made by boiling the desired quantity of water, which is poured under pressure through filter to powder, which then mixes to water and which is in the other receptacle, also proper to serve.

### DESCRIPTON OF MATERIALS USED AND PARTS

MATERIALS: In order to make parts to be described below, microwave oven-resistant materials and proper for foods will be used. A filtering sieve to be made in stainless steel and inner walls of the receptacle to serve will be made in aluminum and plastic-coated; in all pieces plastic (Polieter Imida PEI) will be used, which is unbreakable, transparent, resistant to high temperatures and meets FDA standards in USA. Such plastic may also be substituted, only in the common cover, by another plastic as Polypropylene Randon Polymer—RP-141 or other ones, having at least its same technical specifications.

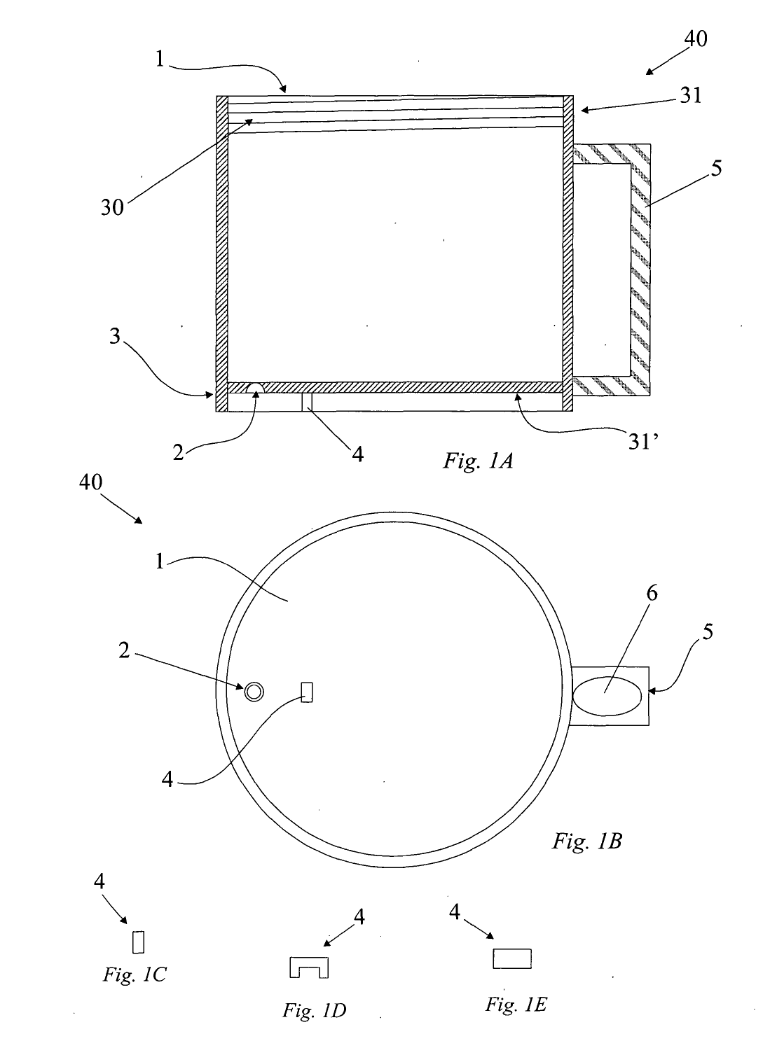

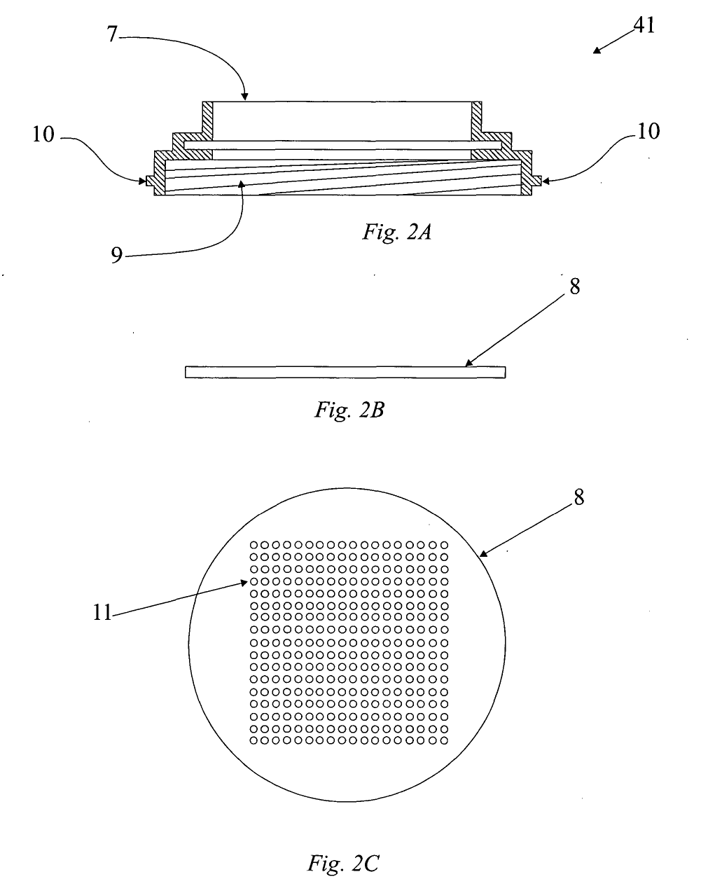

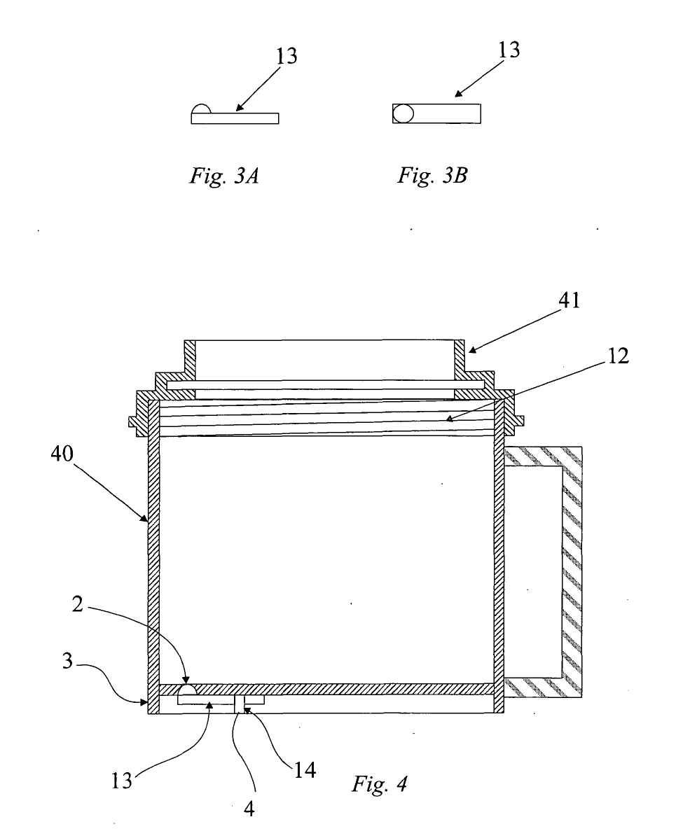

PARTS (numbered as FIGURES): BOILING RECEPTACLE 40—(FIG. 1—Cross Section and FIG. 1.1—top view): the cylinder-shaped, receptacle, containing either in its first opening 1 or first part 31 an outside thread 30, in order to have the COVER 41 WITH A FILTER 8 (see—FIG. 2) may be threaded thereto; it contains in its bottom wall 31′, a very small excavated hole 2 in the thickness of this wall, in the format of a half hollow sphere with larger diameter (0.5 mm) turned outwards, intended to form a Safety Valve 13 together with the external part 4 which is a FIXED SUPORT (see—FIG. 1.2—Cross section, FIG. 1.3—Longitudinal section and FIG. 1.4—Top view), in a rectangular lug shape, where the PRESSURE SEALING 50 PIECE—(see FIG. 3) will be fitted; it further has a small base 3 which is ring-shaped or tapered axially opposing to the first opening 1 (extension of lateral walls beyond the bottom), which serves as a base to the piece, when the latter has its opening upwards; still in its outside part, it has a hollow lug (5) in horizontal extensions (6), which serves to grip this receptacle whatever position, whose utility is distinguished when it is very hot.

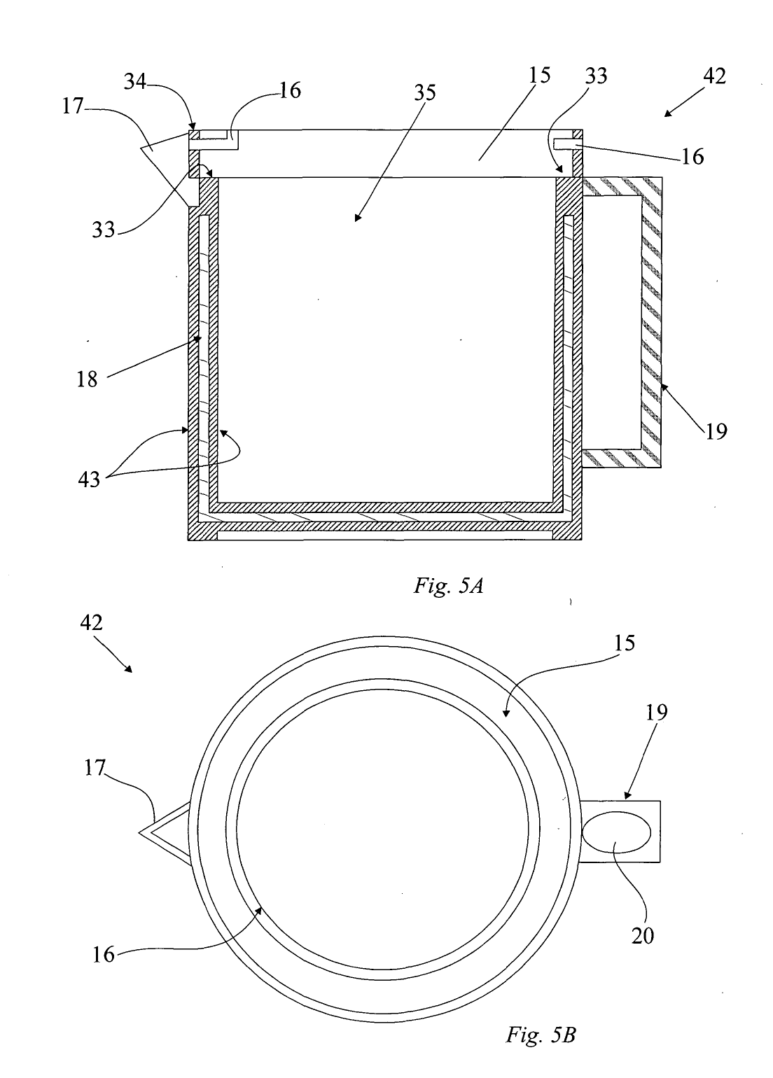

COVER 41 WITH FILTER 8—(FIG. 2—Cross Section) containing a FILTER (see FIG. 2.1—Cross Section and FIG. 2.2—Top view): it is made by injection at stainless steel filter 8 edges, having circular format and smooth edge, containing small holes 11 with less than 1 mm thick at the surface, and serve to filter the coffee powder, allowing the liquid to pass, however retaining powder, and likewise tea or similar particles; it contains an inner thread 9 to fasten threaded 12 to the first opening 1 of COMPLETE BOILING RECEPTACLE 40 (see FIG. 4); it will be made in three dimensions with small holes 11 according to its destination: for coffee, soluble products, water or tea; and for milk or chocolate; externally, near threaded mouth, it has at least two pins 10 which will be fitted into the RECEPTACLE FOR STRAINED ITEMS AND/OR TO SERVE 42 ON THE TABLE (see FIG. 5).

PRESSURE SEAL—(FIG. 3—Cross Section and FIG. 3.1—Top view); a rectangular format plastic piece, having in one of its ends and at the width part, the added form of a convex half sphere which will fit into the concavity 2 existing at the bottom of the BOILING RECEPTACLE (see FIG. 1) for sealing, it being fastened to the lug 14 of the outside bottom of the COMPLETE BOILING RECEPTACLE 40 (see FIG. 4), thereby forming a SAFETY VALVE 13 of this receptacle.

BASIC BOILING RECEPTACLE 40—(FIG. 4, Cross section): formed by the set of parts of the BOILING RECEPTACLE (see FIG. 1) of the COVER WITH FILTER (see FIG. 2) threaded thereto 12 and by the SAFETY VALVE 13 formed with the fitting to the receptacle 14 of the PRESSURE SEAL (see FIG. 3). This BASIC BOILING RECEPTACLE, in itself constitutes a Multiboiling Appliance 50 representing the concept or spirit of the invention and can operate individually, by following certain technical cautions, if coupled to other receiving bases of liquids, such as a common aluminum bowl, for example.

RECEPTACLE FOR STRAINED ITEMS AND/OR TO SERVE—(FIG. 5—Cross section and FIG. 5.1—Top view): cylindrical receptacle, having throughout dimension of its lateral walls and bottom, plastic-covered 43 and bowl-shaped aluminum piece 18 forming the receptacle, intended to prevent direct action of microwaves in the liquid inside it; it has a second upper opening 15 of a larger diameter above the liquid flowing nozzle 17 which serves to form an internal protrusion 33 where he cover of BASIC BOILING RECEPTACLE (see FIG. 4) will be supported and fitted, turned 180° (upside down), which also will be fastened through fitting of cover pins 10 into the fit openings 16 existing at upper walls 34 of the draining opening 35 of this receptacle, which also has a lug 19 in rectangular wing format to be gripped by the second opening 15, this lug 19 containing openings 20 at upper and bottom horizontal parts which connect it with the receptacle.

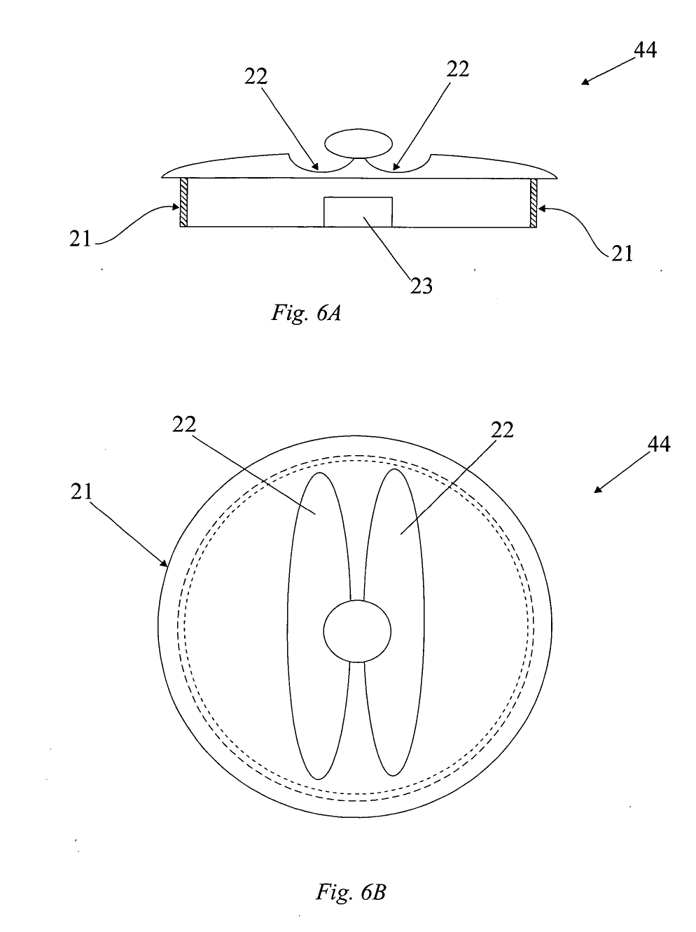

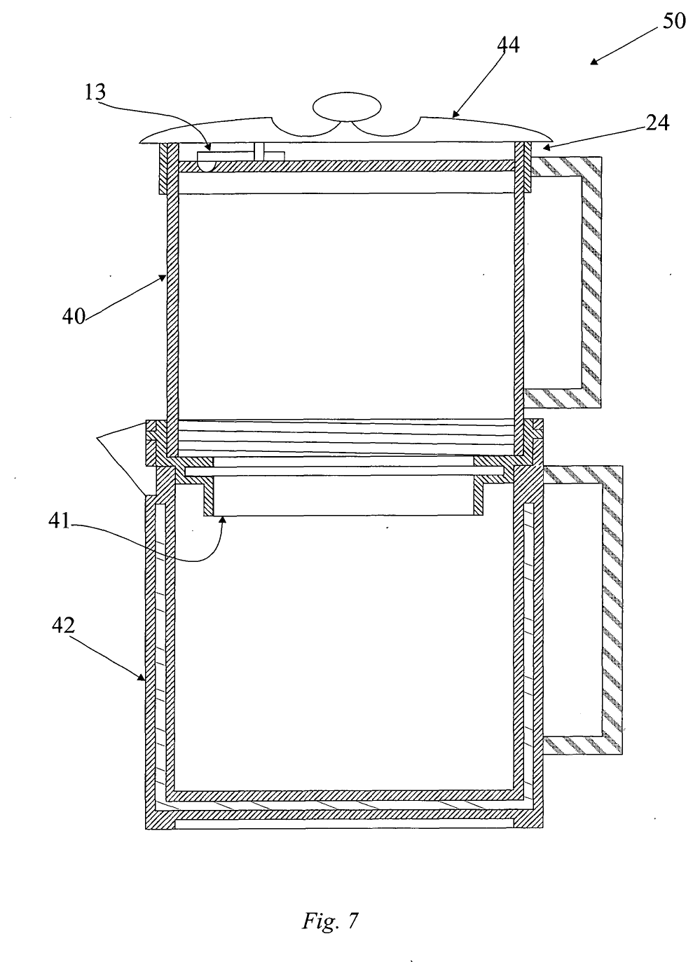

SECOND COMMON COVER 44—(FIG. 6—Cross Section and FIG. 6.1—Top view); made in plastic, with a cylindrical format, it contains in its upper part two parallel lowerings 22 to hold it through finger fitting, and a cylinder-shaped lateral wall 21 containing a rectangular hollow 23 intended both to fit into the a second upper opening of the RECEPTACLE FOR STRAINED ITEMS AND/OR TO SERVE 42—(see FIG. 5) and over the bottom 24 of the BOILING RECEPTACLE 40 (see—FIG. 1), when it is in reverse position, at 180° (upside down), forming the MICROWAVE MULTIBOILING APPLIANCE 50 (see FIG. 7).

MICROWAVE MULTIBOILING APPLIANCE 50—(FIG. 7—Cross Section; formed by the mounted and coupled assembly of above-described parts, namely: BOILING RECEPTACLE 40 (see FIG. 1); COVER 41 WITH FILTER 8 (see FIG. 2); PRESSURE SEAL (see FIG. 3); RECEPTACLE FOR STRAINED ITEMS AND OR TO SERVE 42 (see FIG. 5), intended, in this position, with or without upper cover, to work as a multiboiler of liquids such as water, tea, coffee, milk, chocolate, etc.

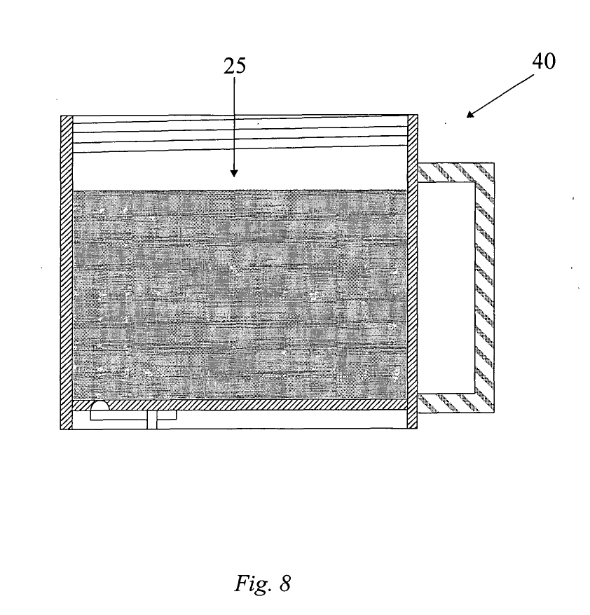

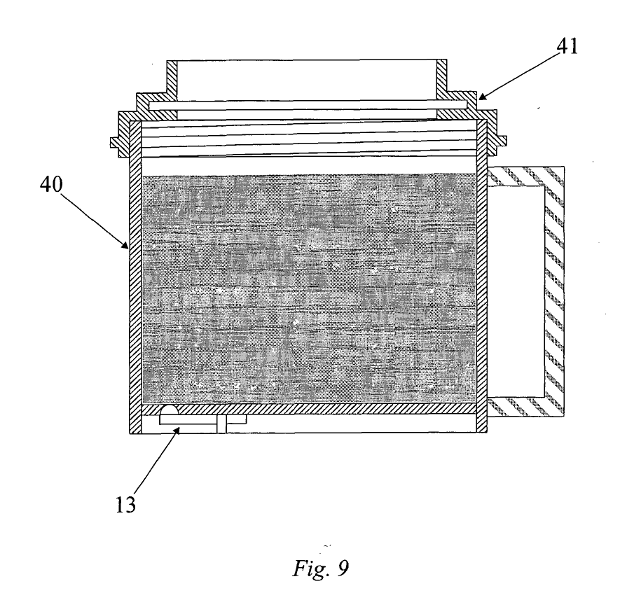

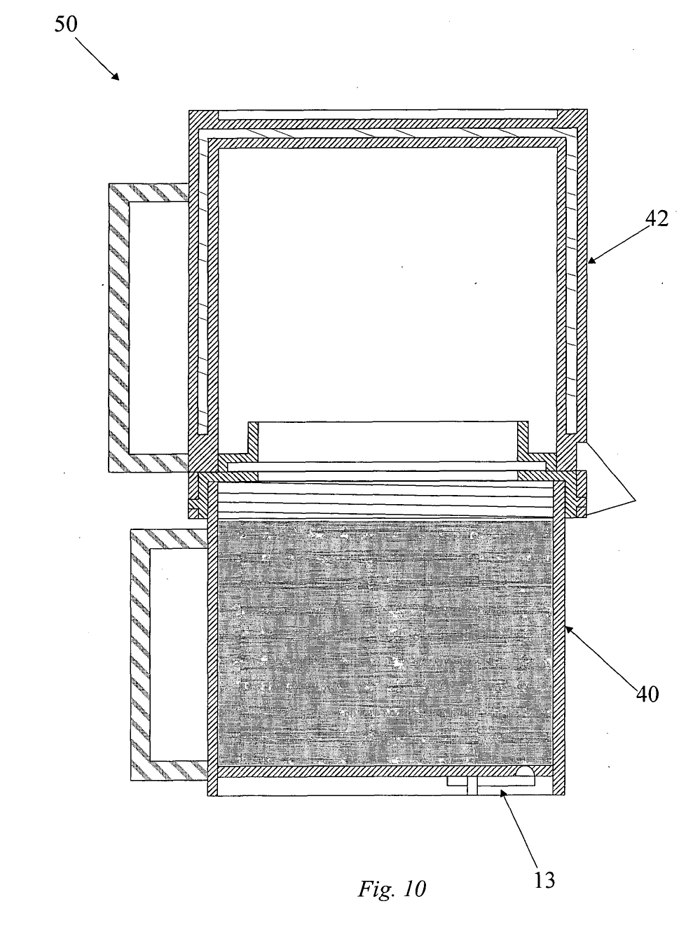

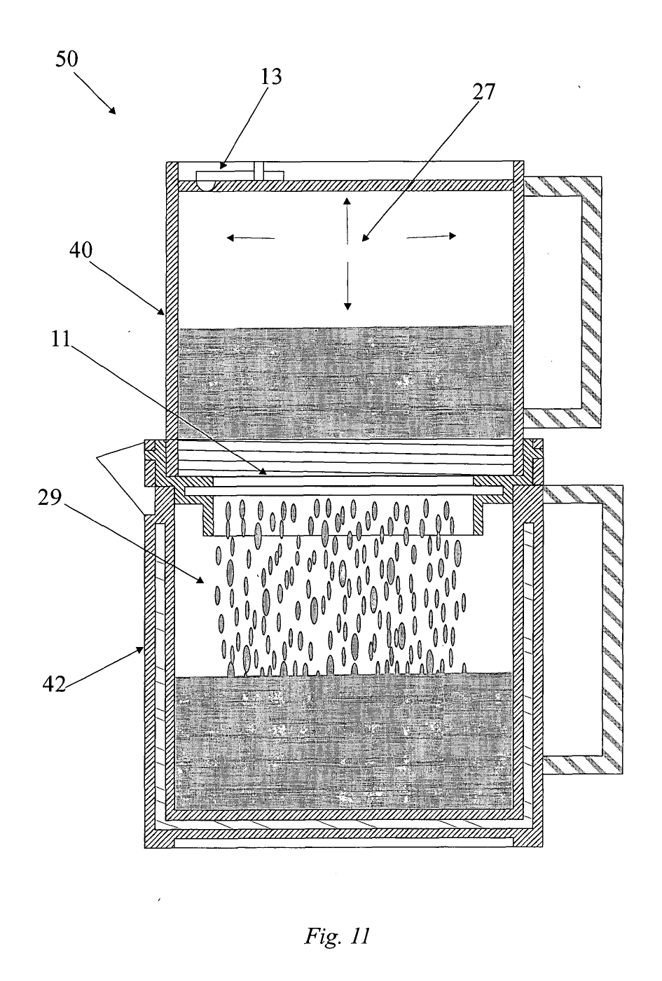

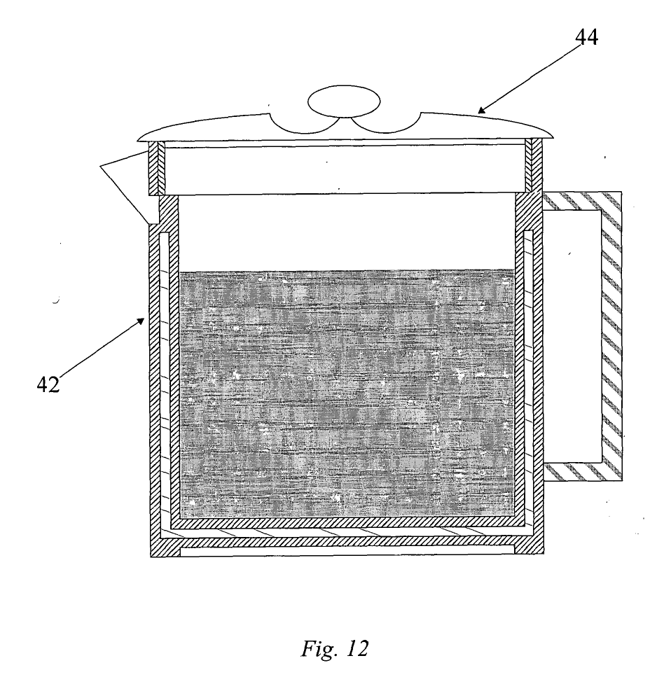

RETAILED DESCRIPTION OF THE INVENTION OPERATION: BOILING RECEPTACLE—POSITION OF PREPARATION (see FIG. 8)—BASIC BOILING RECEPTACLE—POSITION OF PREPARATION (see FIG. 9)—MICROWAVE MULTIBOILING APPLIANCE IN OPERATION—POSITION OF PREPARATION (see FIG. 10); MICROWAVE MULTIBOILING APPLIANCE IN OPERATION—POSITION OF BOILING (see FIG. 11); RECEPTACLE FOR STRAINED ITEMS AND/OR TO SERVE WITH LIQUID—(see FIG. 12).

The following comments describe the operation of multiboiling appliance for straining or making express coffee, with standard express coffee powder, whose most procedures are common in its general use.

One takes the BOILING RECEPTACLE 40—POSITION OF PREPARATION (see FIG. 8) with the SAFETY VALVE 13 assembled and in normal position, with the first opening 1 upwards, and placed in it 25 water and coffee powder according to recommended measures. Then, it is placed externally, threading the COVER 41 WITH FILTER 8 around its first opening, thereby forming the BASIC BOILING RECEPTACLE 40 (see FIG. 9) which is in position of temperature preparation.

Then, one takes the RECEPTACLE FOR STRAINED ITEMS AND/OR TO SERVE 42 of FIG. 5, by turning it 180°, upside down, makes the fitting of its second opening 15 into the external pins 10 of the cover 41 of the BASIC BOILING RECEPTACLE 40, thereby forming the MICROWAVE MULTIBOILING APPLIANCE 50 IN OPERATION—POSITION OF PREPARATION (see FIG. 10), which in this position, for temperature preparation to extraction under pressure, it should be taken to the inner center of the Microwave Oven and after closing the oven cover, the maximum temperature should be driven for one minute (full at half volume of the receptacle) far up to two minutes (full at total volume of the receptacle), the quantity of liquid in the receptacle depending on the temperature preparation which, in being higher, will need additional time, contrary to the quantity of powder used that, in being higher, one will need less time for elevation to the same temperature as desired. Such a temperature of preparation the liquid aims to raise it from 55° C. to 75° C. approximately, which occurs both in this time or in another, according to the oven used and specific instructions given.

After the preparation time, the MICROWAVE MULTIBOILING APPLIANCE 50 is removed from the oven and should be rotated 180°, thereby inverting its position, the RECEPTACLE FOR STRAINED ITEMS AND/OR TO SERVE 42 (see FIG. 5) remaining in the lower part, and in the upper part, inverted at 180°, the BASIC BOILING RECEPTACLE 40 (see FIG. 4), thereby forming the MICROWAVE MULTIBOILING APPLIANCE 50 IN OPERATION in BOILING POSITION (see FIG. 11), which will be taken once more to the center of the microwave oven, and at no time the appliance should be placed in a proximity near to or lower than 3 cm of oven laterals, that is, out of the rotary dish, or further, together with another metallic piece, since it could cause sparkling and damage the oven.

After one minute and thirty seconds (or in accordance with instructions for the specific oven), at the maximum temperature, the liquid composed of water and coffee will start boiling inside the BASIC BOILING RECEPTACLE 40 which, in accumulating internal pressure with the vapor 27 will expel the liquid of boiling coffee outwards, which will be done by the only outlet, through very small holes 11, 28 existing in the stainless steel filter, which will allow only the release of liquid added from coffee properties, retaining the powder. The liquid coffee will pass through the filter 8 and will fall ready 20 into the RECEPTACLE FOR STRAINED ITEMS AND/OR TO SERVE 42 (see FIG. 11).

As soon as the entire coffee is filtered, within the pre-established time, either the appliance should be removed from the microwave oven and taken directly to the table, or otherwise, preferably over the kitchen sink, the RECEPTACLE FOR STRAINED ITEMS AND/OR TO SERVE 42 WITH COVER (see FIG. 12) will be disconnected from it, which is covered in order to serve the ready coffee, leaving in the sink the piece of BASIC BOILING RECEPTACLE 40 removed, where it will be washed after removing powder accumulated with filter, directly to the trash.

The coffee made with the multiboiling appliance 50 of the present invention will be highly pure and sterilized, since only noble materials have been used, proper to be used in foods which do not suffer any degradation action when submitted to oven microwaves.

The taste of the coffee, tea or chocolate will be highly refined due to the use of microwaves in the boiling only, and due to the non-use of fabrics or paper at the filtering process. The coffee will have an excellent and unequalled taste, since it was also boiled under pressure only together water.

The appliance operates without any liquid spillage inside the microwave oven, and this is the reason why the RECEPTACLE FOR STRAINED ITEMS AND/OR TO SERVE 42, as it contains aluminum internal walls, seals the action of microwaves inside it, while filtering and receiving liquid it is expelled through the filter thereby preventing liquid from reboiling inside it during such a filtering.

In the very remote case of filter clogging, inner pressure of the receptacle will increase to the point of activating the existing safety valve 13 existing, allowing the decompressing through vapor release through this valve. Should in another even more remote case, the safety valve 13 do not work, the inner pressure will cause, through the force it will exercise, the direct disconnection at the threading place of the COVER 41 WITH FILTER 8 (see FIG. 2) of the BOILING RECEPTACLE 40 (see FIG. 1), which will cause liquid spillage inside the microwave oven only, and so, the total safety of the present invention is demonstrated.

On the other hand, in order to use the same appliance to make tea, both with loose herbs, leaves or even in sachets, one should follow the same procedures as to make coffee, changing only the coffee powder into tea and at the time of temperature preparation for extraction under pressure, time used to coffee should be duplicated, since tea demands a longer time for extraction of its properties. As to the inverse position to boil and strain, the appliance placed again inside the microwave will take at most one minute to filter the boiling tea to receptacle for serving.

As to pure milk, it takes on average the same time of temperature preparation for extraction under pressure as used to coffee; and in order to boil and strain, it will take at most one minute to pass entirely to the receptacle to serve, the same happening by adding either chocolate or cocoa to milk either before or after the temperature preparation.

In order to make soluble coffee, one should take into consideration that the best procedure is pouring boiling water over powder.

For such a purpose, the COMPLETE BOILING RECEPTACLE 40 should be full with filtered water and taken directly to microwave woven for temperature preparation for extraction under pressure and there leave it at the same time as mentioned for preparation of express coffee, while the quantity of soluble coffee suitable to the volume of water placed in the other receptacle is placed in the RECEPTACLE OF STRAINED ITEMS AND/OR TO SERVE 42. After such a preparation time, the COMPLETE BOILING RECEPTACLE 40 is removed from the Microwave Oven and turning it upside down, that is, rotating it 180°, one fits it into the RECEPTACLE FOR STRAINED ITEMS AND/OR TO SERVE 42, which will already contain the soluble powder over which boiled water will be poured, expelled from the boiling receptacle, at the maximum time of one minute.

A time table for heating with the temperature according to marks of the Microwave Oven and according to contents of the liquid preparation to boil, will follow the appliance for user's guidance during the initial understanding on the use thereof.

As each user will use its appliance in the microwave oven it has, it will end up knowing rapidly the own temperature time table to use, which will not depend on the temperature standard adopted by the other microwave oven manufacturers.

What is claimed:

1. A microwave multiboiling apparatus for preparing liquids using microwave energy, said apparatus comprising:
a boiling receptacle having a first opening, a sidewall, and a base disposed opposite said first opening, said base defining an excavation hole therein,
a substantially circular cover having a first end and a second end, said circular cover defining an aperture for housing a filter, said first end of said cover being removably mounted to said first opening of said boiling receptacle;
a filter having a plurality of holes, said filter being housed within said aperture of said circular cover; and
a serving receptacle having a draining opening, a second opening, a metallic inner wall coated with polymeric material, and a liquid flowing nozzle, said serving receptacle being removably mounted to said second end of said circular cover.

2. The apparatus according to claim 1, wherein said boiling receptacle further includes an outer thread disposed in said first opening.

3. The apparatus according to claim 2, wherein said boiling receptacle further includes an external structure hinged to said base of said boiling receptacle proximate to said excavation hole.

4. The apparatus according to claim 2, wherein said first and second circular cover is internally threaded and includes a plurality of external pins.

5. The apparatus according to claim 4, wherein said internal threads of said first end of said circular cover are disposed adjacent to outer threads disposed on said boiling receptacle.

6. The apparatus according to claim 1, wherein said second opening of said serving receptacle includes an internal protrusion, an upper wall, and a plurality of fit openings.

7. The apparatus according to claim 4, wherein said circular cover is secured to said serving receptacle using said plurality of external pins.

8. The apparatus according to claim 1, further comprising a second cover removably mounted to said boiling receptacle.

9. The apparatus according to claim 1, further comprising a second cover removably mounted to said serving receptacle.

10. A method for preparing liquids using a multiboiling apparatus, said method comprising:
placing a mixture of water and a selected substance, such as coffee powder or other type of powder, into a boiling receptacle through a first opening;
securing a cover, having a filter incorporated therein, to said boiling receptacle;
securing a serving receptacle to said cover to form a multiboiling apparatus;
heating said multiboiling apparatus a first time sufficiently for preparing said mixture;
heating said multiboiling apparatus a second time sufficiently to boil said mixture and produce a vapor inside of said boiling receptacle and a resultant liquid; and
storing said resultant liquid in said serving receptacle.

11. The method according to claim 10, further comprising threading said cover into said boiling receptacle.

12. The method according to claim 11, further comprising securing said serving receptacle to said cover by means of a plurality of pins on the outside of said cover.

13. The method according to claim 10, further comprising rotating said multiboiling apparatus longitudinally 180 degrees subsequent to heating said multiboiling apparatus said first time and prior to heating said multiboiling apparatus said second time.

14. The method according to claim 10, further comprising passing said mixture through a plurality of holes in said filter by utilizing an accumulation of internal pressure in said boiling receptacle.
